(19) United States
(12) Patent Application Publication
(10) Pub. No.: US 2022/0352574 A1
(43) Pub. Date: Nov. 3, 2022

(54) Insulating Materials And Methods Thereof

(71) Applicant: 3M INNOVATIVE PROPERTIES COMPANY, St. Paul, MN (US)

(72) Inventors: Mingzhu Lu, Shanghai (CN); Pingfan Wu, Woodbury, MN (US); Zhaogang Wang, Shanghai (CN)

(21) Appl. No.: 17/766,157

(22) PCT Filed: Oct. 31, 2019
(86) PCT No.: PCT/CN2019/114753

§ 371 Date: Apr. 1, 2022

(51) Int. Cl. H01M 10/658; B32B 27/12; B32B 27/32; B32B 3/26; B32B 27/30; B32B 27/28; B32B 5/02

(52) U.S. Cl. CPC H01M 10/658; B32B 27/12; B32B 27/322; B32B 3/266; B32B 27/304; B32B 27/281; B32B 5/022; H01M 2220/20; B32B 2307/304; B32B 2457/10; B32B 2307/546; B32B 2262/0223; B32B 2262/0284

(57) ABSTRACT

Insulating articles, assemblies and methods are provided. The insulating articles include a core layer (101,201) containing a plurality of non-meltable fibers; and at least one reinforcement layer (102, 202) disposed on the core layer (101,201). The insulating article has tensile strength of at least 0.75 newtons/millimeter according to ASTM D822 and a tear strength of at least 2 newtons under ASTM D1938, wherein the insulating article has a surface electrical resistivity of at least 15 M-ohm at a relative humidity of 85% and temperature of 30° C., wherein the insulating article has an air flow resistance of up to 2000 MKS Rayls according to ASTM C522, and wherein the insulating article displays a UL94-V0 flammability rating.

### FIELD OF THE INVENTION

Provided are thermally insulating articles. The thermally insulating articles may be used in automotive and aerospace applications, such as battery compartments for electric vehicles.

### BACKGROUND

Extreme temperatures can substantially degrade the performance and lifetime of a battery. This is of particular concern for batteries used in electric vehicles, which are used and stored outdoors. Freezing temperatures can impair both vehicle acceleration performance and driving range, while high temperatures can result in power fade and reduced battery life. Manufacturers bear the burden of mitigating these technical challenges, since consumers have come to expect that these batteries will perform consistently for many years.

While lithium ion batteries can provide high power densities relative to competing battery technologies, their performance can be limited by their relatively narrow working temperature range. A thermal management system can control working temperatures by using a thermostat in conjunction with a chiller or heater that switches on when battery temperatures fall outside of the working temperature range. These devices may be powered by the battery itself or by a secondary battery, tend to be energy intensive, and need to be carefully managed to avoid depleting charge in the battery.

A passive thermal insulator can help reduce this energy expenditure by slowing the rate at which heat is lost to the outside environment. This has the ancillary benefit of reducing the power consumption associated with heating or cooling the battery, providing a more uniform temperature distribution across the cells within the battery, and reduce hazards associated with uncontrolled temperatures.

### SUMMARY

Thermal insulators have many technical requirements, some of which are surprising. First, to be effective, these materials not only require a sufficiently high R-value (a measure of its thermally insulating property) but also sufficient mechanical strength. This property, which can be characterized by tear strength and/or tensile strength of the insulator, enables the insulator to maintain its integrity when handled and installed and provides resistance against minor deflections and deformations in the spaces around the battery that occur during use.

Second, thermal insulators should be fire resistant. Modern batteries can have high power densities, which increase the risk of a battery component catching fire. As a result, car manufacturers generally require that components of the battery and the compartment around the battery pass the UL94-V0 flammability test.

Third, it is generally desirable for the thermal insulator to display high electrical resistivity. Battery packs for electric vehicles can be subjected to high voltages and temperatures during use and while recharging. The power leakage measured is in voltage square divided by the total system electrical resistance. To minimize this power leakage, it is advantageous for insulation materials to have, intrinsically, as high an electrical resistance as possible.

Fourth, having a thermal insulator with sufficient permeability is also beneficial to vent trapped moisture. Many materials, when cooled from high temperatures, can trap condensed water, resulting in a drop in surface electrical resistivity. It was found, for instance, that the electrical resistivity of certain insulating materials can drop from 950 M-ohm when dry (25° C. 20% RH) to 30 M-ohm when conditioned at 25° C. 65% relative humidity. Moreover, many high voltage battery systems cannot be hermetically sealed, because doing so can cause housing deformation or even rupture as a result of pressure differences between the environment and the system interior. Sometimes these battery systems use a semi-permeable membrane that is permeable to gases but prevents liquid water from entering the battery.

It can be difficult to address all of these requirements simultaneously because making improvements in one area can degrade performance in another. For example, doping polyesters with phosphate-based flame-retardant additives can improve fire resistance but increases moisture uptake in these materials, thereby reducing their electrical resistivity. Certain materials such as polyimide films can retain a high electrical resistivity as humidity level changes. These films are not breathable, however, which can entrap condensed moisture within the insulating material.

In sum, the need remains for a passive thermal insulation material that has sufficient insulating performance and mechanical strength, is fire resistant, while retaining high electrical resistivity in humid environments.

In a first aspect, an insulating article is provided. The insulating article comprises: a core layer containing a plurality of non-meltable fibers; and optionally at least one reinforcement layer disposed on the core layer, wherein the insulating article has tensile strength of at least 0.75 newtons/millimeter according to ASTM D822 and a tear strength of at least 2 newtons under ASTM D1938, wherein the insulating article has a surface electrical resistivity of at least 15 M-ohm at a relative humidity of 85% and temperature of 30° C., wherein the insulating article has an air flow resistance of up to 2000 MKS Rayls according to ASTM C522, and wherein the insulating article displays a UL94-V0 flammability rating.

In a second aspect, a battery assembly is provided comprising a battery at least partially enclosed by the insulating article.

In a third aspect, a method of insulating an electric vehicle battery is provided, the method comprising at least partially enclosing the electric vehicle battery with the insulating article.

### BRIEF DESCRIPTION OF THE DRAWINGS

FIG. 1 is a side cross-sectional view of a thermal insulator according to one exemplary embodiment;

FIG. 2 is side cross-sectional view a thermal insulator that has been heat sealed according to another exemplary embodiment; and

FIG. 3 is a side cross-sectional view of a thermal insulator assembly.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### Definitions

As used herein:

“ambient conditions” means at 23° C. and 101.3 kPa pressure;

“average” means number average, unless otherwise specified;

“copolymer” refers to polymers made from repeat units of two or more different polymers and includes random, block and star (e.g. dendritic) copolymers;

“average fiber diameter” of fibers in a non-woven core layer is determined by producing one or more images of the fiber structure, such as by using a scanning electron microscope; measuring the transverse dimension of clearly visible fibers in the one or more images resulting in a total number of fiber diameters; and calculating the average fiber diameter based on that total number of fiber diameters;

“non-woven core layer” means a plurality of fibers characterized by entanglement or point bonding of the fibers to form a sheet or mat exhibiting a structure of individual fibers or filaments which are interlaid, but not in an identifiable manner as in a knitted fabric;

“polymer” means a relatively high molecular weight material having a molecular weight of at least 10,000 g/mol;

“size” refers to the longest dimension of a given object or surface;

“substantially” means to a significant degree, as in an amount of at least 30%, 40, 50, 60, 70, 80, 90, 95, 96, 97, 98, 99, 99.5, 99.9, 99.99, or 99.999%, or 100%;

“surface electrical resistivity” refers to a fundamental property of a material that quantifies how strongly it resists the flow of an electric current along its surface, such as characterized by the Surface Electrical Resistivity Test in the Examples; and

“thickness” means the distance between opposing sides of a layer or multilayer article.

### DETAILED DESCRIPTION

As used herein, the terms “preferred” and “preferably” refer to embodiments described herein that can afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein. Relative terms such as left, right, forward, rearward, top, bottom, side, upper, lower, horizontal, vertical, and the like may be used herein and, if so, are from the perspective observed in the particular drawing. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Where applicable, trade designations are set out in all uppercase letters.

### Insulating Articles, Assemblies, and Methods of Manufacture

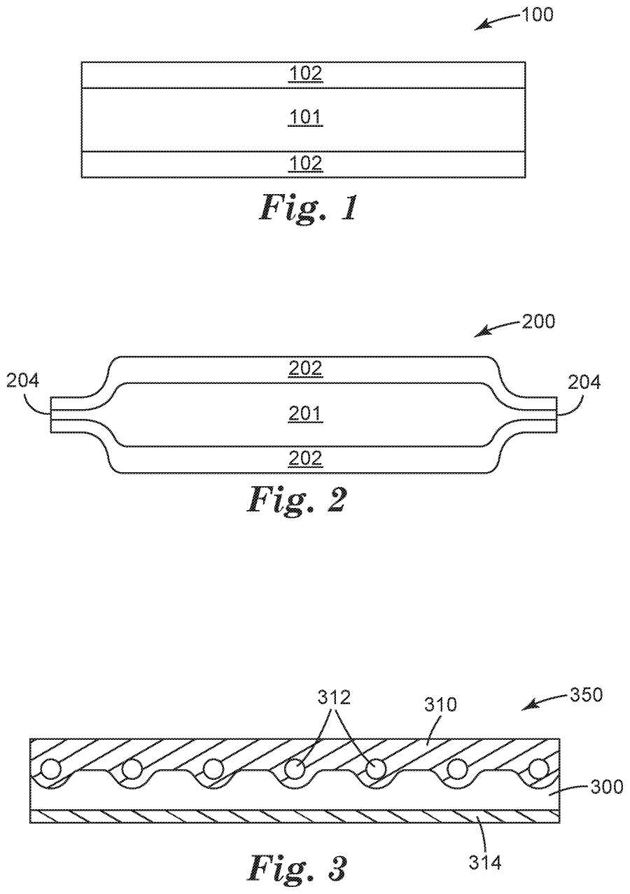

Broadly, the provided insulating articles are comprised of thermal insulators. A thermal insulator according to one embodiment is shown in FIG. 1 and hereinafter referred to by the numeral 100. The thermal insulator 100 includes a core layer 101 disposed between a pair of reinforcement layers 102, 102. In the depicted embodiment, the core layer 101 is a non-woven fibrous web. As shown, the reinforcement layers 102, 102 are diametrically opposed, with each reinforcement layer 102 extending across and directly contacting the core layer 101.

The reinforcement layers 102 can provide improved strength, toughness, and/or friability to the overall insulator 100 as compared to that of the core layer 101 alone. As shall be later discussed, the reinforcement layers 102 may also provide alternative functionalities, such as fire barrier properties.

For enhanced flame resistance, it can be advantageous for the core layer and/or reinforcement layers to be made from a non-meltable material. For example, one or more of the core layer and reinforcement layers can be made from a non-woven fibrous web comprised of carbonaceous fibers. Optionally, one or more binders are disposed in the core layer and/or reinforcement layers to assist in adhering these layers to each other. As another example, the core layer may be made from a non-woven fibrous web comprised of carbonaceous fibers while the reinforcement layers are thermoplastic fluoropolymer films.

It is to be understood that the core layer 101 and reinforcement layers 102, 102 are broadly designated, and variations and permutations of these layers are possible. For example, either one of the reinforcement layers 102 may be omitted, such that one of the major surfaces of the core layer 101 is exposed. As a further option, it is also possible for the reinforcement layers 102, 102 to have two different compositions or configurations.

In the depicted embodiment, the two reinforcement layers 102, 102 are separated by the core layer 101 and do not contact each other. In alternative embodiments, the reinforcement layers 102, 102 could be joined to each other along one or more peripheral edges of the unsealed thermal insulator 100 to form an envelope, or pouch, within which the non-woven core layer 101 resides. Similarly, the reinforcement layers 102, 102 could be two halves of a single reinforcement layer that is folded over along one peripheral edge of the unsealed thermal insulator 100, with the non-woven core layer 101 disposed between the two halves.

FIG. 2 shows a thermal insulator 200 bearing certain similarities to the thermal insulator 100 of FIG. 1. Like the thermal insulator 100, the thermal insulator 200 includes a core layer 201 confined between a pair of reinforcement layers 202 in a three-layer sandwich configuration. As shown, the peripheral edges 204, 204 of the thermal insulator 200 are permanently compressed to form respective edge seals.

In a preferred embodiment, the edge seal extends along the entire perimeter of the thermal insulator 200. Alternatively, the edge seal can extend only along a portion of the perimeter of the thermal insulator 200. In the former case, edge sealing effectively encapsulates the non-woven core layer 201, along with any loose fibers therein, between the pair of reinforcement layers 202. Generally, the edge sealed regions are relatively narrow to avoid any degradation in insulation performance that might be caused by compressing large areas of the thermal insulator 200.

The reinforcement layers 202, whether solid or porous, effectively captures loose fibers and prevents fibers from being shed from the thermal insulator 200. Shedding of fibers is generally undesirable because it introduces contamination issues for both the manufacturer and end user. Where the fibers of the core layer 201 are electrically conductive, escaping fibers can also create unintended paths for electrical current, a problem avoided by this configuration.

The peripheral edges of the reinforcement layers 202, 202 can be sealed using any known method. One method is by heat sealing, a process in which heat and pressure are applied to outer-facing surfaces of the reinforcement layers 202, 202 to compress and force out voids in both the reinforcement layers 202, 202, and the non-woven core layer 201 to form a seal. The reinforcement layers 202, 202 and/or core layer 201 can, in some embodiments, include or contain a meltable material, such as a thermoplastic resin, capable of interpenetrating all of the layers in the edge seal when molten and, maintaining the seal when cooled.

Other edge sealing processes are also possible. For example, edge sealing can be achieved by cold welding, a process in which two surfaces join at the atomic level without any liquid or molten phase being present at the joint. Edge sealing can also occur adhesively, where a liquid adhesive fills the interstices within the reinforcement layers 202, 202 and the non-woven core layer 201 along the edge seal. Finally, edge sealing can also be achieved by ultrasonic welding, or by mechanical means such as by stitching or use of fasteners. Any of these methods can effectively prevent escape of loose fibers borne from the core layer 201.

The non-woven core layer and reinforcement layers need not be coextensive. For example, the reinforcement layers 202, 202 can be made larger in area than the non-woven core layer 201 such that the peripheral edges of the reinforcement layers 202, 202 do not overlap with the peripheral edge of the non-woven core layer 201. The peripheral edge may extend along the entire perimeter of the thermal insulator 200 and include the reinforcement layers 202, 202 but exclude the non-woven core layer 201. This configuration can reduce compression of the core layer 201 and prevent fibers from the core layer 201 from being exposed on the outer surface of the finished product.

The provided thermal insulators display a combination of technical features that are advantageous for battery compartment applications. While conventional solutions may show some of these features, the provided insulators are capable of achieving all of them. This is notable, given that at least some of these are material properties that tend to be inversely related to each other.

First, these insulators display properties that ensure their structural integrity during handling and use. Conventional insulators, particularly those containing fine fibers, can abrade or tear when being handled and installed, leading to undesirable fiber shedding. This is especially problematic with respect to carbonaceous fibers, which are generally more brittle than thermoplastic fibers.

By pairing an insulating core layer with one or more reinforcement layers, it is possible to provide a thermal insulator having an overall tensile strength of at least 0.75 newtons per millimeter, at least 2 newtons per millimeter, at least 5 newtons per millimeter, or in some embodiments, less than, equal to, or greater than 0.1 newtons per millimeter, 0.2, 0.5, 0.75, 1, 1.5, 2, 2.5, 3, 3.5, 4, 4.5, or 5 newtons per millimeter, according to ASTM D822. In some embodiments, the provided thermal insulators have an overall tear strength of at least 0.1 newtons, at least 2 newtons, at least 5 newtons, or in some embodiments, less than, equal to, or greater than 0.1 newtons, 0.2, 0.5, 0.7, 1, 1.5, 2, 2.5, 3, 3.5, 4, 4.5, or 5 newtons, according to ASTM D1938-14.

Another property relevant to preserving the structural integrity of the provided insulators is flexibility. The flexibility of a given insulating article can be measured using any of a number of ways, including the Flexibility Test described in the forthcoming Examples section. The test uses an instrument called a Handle-O-Meter, which measures the amount of force required to mechanically press a sample into a slot of pre-determined width. In a preferred embodiment, the insulating article has a flexibility of up to 30 grams, up to 40 grams, up to 50 grams, or in some embodiments, less than, equal to, or greater than 10 grams, 15, 20, 25, 30, 35, 40, 45, 50, 55, or 60 grams, when measured according to the Flexibility Test.

Second, the provided insulators are permeable, particularly to air and water vapor. In a preferred embodiment, the core layer and each reinforcement layer in the insulating article is permeable. Moisture is known to induce low level corrosion currents in lithium ion batteries in the presence of ionic impurities. By creating a pathway for vapors to escape, these articles avoid entrapment of moisture within the battery compartment and corrosion currents that might arise as a result of such moisture. A permeable structure also reduces the hazards of pressurization should a fire or adverse chemical reaction occur within the battery compartment. Reflecting this, the insulating article can have an air flow resistance of up to 100 MKS Rayls, up to 2000 MKS Rayls, up to 10,000 MKS Rayls, or in some embodiments, less than, equal to, or greater than 10 Rayls, 20, 50, 70, 100, 150, 200, 250, 300, 350, 400, 450, 500, 600, 700, 800, 900, 1000, 1200, 1500, 1700, 2000, 3000, 4000, 5000, 7000, or 10000 MKS Rayls, according to ASTM C522.

Third, the provided insulators are made from materials that intrinsically repel, or resist adsorption of, moisture. In some embodiments, this property can be enhanced by using a material or sizing that has a low surface energy, or a hydrophobic surface. The avoidance of moisture can help maximize the electrical resistivity (i.e., minimize electrical conductance) of the insulating article. To this end, it is also preferred for the insulating article to be made from materials that intrinsically have a high electrically resistivity in their dry state.

In some embodiments, the insulating article has a surface electrical resistivity of at least 15 M-ohm, at least 20 M-ohm, at least 30 M-ohm, or in some embodiments, less than, equal to, or greater than 10 M-ohm, 15, 20, 25, 30, 35, 40, 45, 50, 60, 70, 80, 90, 100, 200, 500, or 900 M-ohm at a relative humidity of 85% and temperature of 30° C.

Finally, the insulators described herein are flame-resistant and/or flame retardant. This feature is manifested by the insulating article displaying a UL94-V0 flammability rating. To attain a UL-94-V0 standard, it is necessary for samples of the insulating article to satisfy each of the following five criteria: 1) burning combustion is not sustained for more than 10 seconds after applying controlled flame; 2) total flaming combustion time for 5 samples does not exceed 50 seconds; 3) none of the samples burned up to the mounting clamp by either flaming or glowing combustion; 4) none of the samples dripped flaming particles that result in the ignition of the surgical cotton below them; 5) samples did not exhibit glowing combustion for more than 30 seconds after removing a second controlled flame.

It can be possible for a UL-94-V0 rating to be achieved for a multilayered article even in cases where its constituent layers, in isolation, do not achieve a UL-94-V0 rating. Further, the thickness of the overall insulating article can have a significant impact on whether the article achieves a UL-94-V0 flammability rating. For example, an article that uses a relatively dense core layer may not attain a UL-94-V0 rating while one containing a core layer that is relatively expanded may attain a UL-94-V0 rating, even if the raw materials in both cases are identical.

FIG. 3 shows a thermal insulator assembly 350 that incorporates a thermal insulator 300. The thermal insulator 300, a layer within the assembly 350, can have the structure and properties of the thermal insulators 100, 200 previously described. Also contemplated is a battery assembly in which the thermal insulator 300 of the thermal insulator assembly 350 at least partially surrounds a battery, such as an electric vehicle battery.

This exemplary thermal insulator 300 could be used in an electric vehicle battery compartment. As depicted in FIG. 3, the thermal insulator 300 is bounded from above by a compartment wall 310, which can be made from aluminum or copper. Optionally and as shown, a plurality of embedded channels 312 extend through the compartment wall 310 (perpendicular to the plane of the page in FIG. 3). The channels 312 can be used to circulate a liquid coolant such as water, which aids in controlling the temperature of the compartment wall 310.

In the depicted configuration, the interface between the compartment wall 310 and the thermal insulator 300 is non-planar. Preferably and as shown, the thermal insulator is resiliently compressible, enabling it to expand into and fill cavities that might be otherwise create voids from a planar layer being placed in contact with a layer with irregular contours.

On the opposing side, the thermal insulator 300 is bounded from below by a heat shield 314, which extends across and flatly contacts the thermal insulator 300. Either or both of the heat shield 314 and the compartment wall 310 can be made from any of a number of known thermally conductive materials. Suitable materials can include metals such as aluminum and copper, both of which can assist in delocalizing hot spots on a battery compartment.

While battery applications are illustrated and described herein, it is to be understood that the provided thermal insulators need not be so limited. These insulators could also be used for thermal management in other applications, such as internal combustion engines and electric motors.

Any known method of assembly may be used to fabricate the thermal insulators described herein.

In some embodiments, the core layer and reinforcement layers are adhered to each other by a lamination process. Such lamination may use a binder (as described in a forthcoming section below) or adhesive film to bond these layers together. One or more binders, described in a forthcoming section, could be present in the form of particulate binders or binder fibers, either of which can be incorporated into the core layer or reinforcement layer. As another possibility, at least one core layer or reinforcement layer may already have binder-like properties in its constituent components, in which case a separate adhesive or binder is not needed.

Lamination can be achieved by the application of heat and/or pressure. This can be achieved by passing the core layer and reinforcement layer(s) through a pair of heated rollers, or by pressing the layered construction between the heated platens of a hydraulic press.

In some embodiments, heat is not required. For example, a core layer and reinforcement layer may be laminated to each other by mixing a two-part adhesive, spreading it along a major surface of a core layer or reinforcement layer, and curing the adhesive at ambient temperature. Alternatively, a one-part adhesive may be used, which is cured by exposure to actinic radiation.

Instead of, or in addition to, the above lamination methods, layers within the insulating article may be adhered to each other by mechanical interactions. Where the core layer and reinforcement layer are both fibrous, hydroentanglement or needle tacking may be used to mutually entangle fibers of these layers along the z-axis direction (perpendicular to the major surfaces of the layers).

Yet another possibility is to manufacture the core layer and reinforcement layer(s) either simultaneously or sequentially such that fibers within these respective layers become mutually entangled (or enmeshed) at the time they are made. Optionally, the fibers within the web can be bonded together at points of fiber intersection, such as with autogenous bonds, to provide a compression-resistant matrix. Examples of such manufacturing methods are described in U.S. Pat. No. 5,298,694 (Thompson, et al.), U.S. Pat. No. 5,773,375 (Swan, et al.), and U.S. Pat. No. 7,476,732 (Olson, et al.).

### Core Layers

The core layer contains a plurality of fibers that are fire-resistant and processed into a non-woven fibrous web. In a preferred embodiment, the fibers are non-meltable fibers. Non-meltable fibers are made from a material that does not become a liquid at any temperature. In some cases, these polymers do not melt because they oxidize or otherwise degrade first when heated in the presence of air. Non-meltable fibers include carbonaceous fibers. Carbonaceous fibers include carbon fibers, carbon fiber precursors, and combinations thereof.

Carbon fiber precursors include oxidized acrylic precursors, such as oxidized polyacrylonitrile. Polyacrylonitrile is a useful acrylic precursor that can be used widely to produce the carbon fibers. In some embodiments, the polyacrylonitrile contains more than 70 weight percent (wt %), more than 75 wt %, more than 80 wt %, or more than 85 wt % acrylonitrile repeat units.

Non-meltable polymeric fibers other than oxidized polyacrylonitrile fibers may also be used. Such fibers include dehydrated cellulosic precursors such as rayon. Non-meltable polymeric fibers further include lignin fibers. Lignin is a complex polymer of aromatic alcohols known as monolignols, and is derived from plants. Monolignol monomers include p-coumaryl alcohol, coniferyl alcohol, and sinapyl alcohol, which are methoxylated to varying degrees.

Non-meltable polymeric fibers can include certain thermoset materials, such as epoxy, polyimide, melamine, and silicone. Natural fibers, such as cotton, linen, hemp, silk, and animal hairs, simply burn without melting. Rayon is the artificial silk made from cellulose. When cellulose burns, it produces carbon dioxide and water and can also form a char.

Carbon fiber precursors also include pitch-based precursors. Pitches are complex blends of polyaromatic molecules and heterocyclic compounds, which can be used as precursors of carbon fibers or carbon fillers in carbon composites. Vinylidene chloride and phenolic resins can, in some embodiments, be precursors for manufacture of carbon fibers.

In a preferred embodiment, the non-meltable fibers are comprised of oxidized polyacrylonitrile fibers. The oxidized polyacrylonitrile fibers can include, for example, those available under the trade designations PYRON (Zoltek Corporation, Bridgeton, Mo.) and PANOX (SGL Group, Meitingen, Germany).

The oxidized polyacrylonitrile fibers can derive from precursor fibers containing a copolymer of acrylonitrile and one or more co-monomers. Useful co-monomers include, for example, methyl methacrylate, methyl acrylate, vinyl acetate, and vinyl chloride. The co-monomer(s) may be present in an amount of up to 15 wt %, 14 wt %, 13 wt %, 12 wt %, 11 wt %, 10 wt %, 9 wt %, or 8 wt %, or in some embodiments, less than, equal to, or greater than 1 wt %, 2, 3, 4, 5, 6, 7, 8, 9, 10, 11, 12, 13, 14, 15, 16, 17, 18, 19, or 20 wt %, relative to the overall weight of the monomer mixture prior to copolymerization.

Oxidation of the precursor fibers can be achieved by first stabilizing the precursor fibers at high temperatures to prevent melting or fusion of the fibers, carbonizing the stabilized fibers to eliminate the non-carbon elements and finally a graphitizing treatment at even higher temperatures to enhance the mechanical properties of the non-woven fibers. Oxidized polyacrylonitrile fibers, as referred to herein, include polyacrylonitrile fibers that are either partially or fully oxidized. In some embodiments, the plurality of non-meltable polymeric fibers are stabilized, as described in International Patent Publication No. WO 2019/090659 (Cal et al.) and co-pending International Patent Application No. PCT/CN2018/096648 (Li et al.).

The non-meltable fibers of the core layer can have a fiber diameter and length that enables the fibers to become mutually entangled. Further, the fibers preferably have a sufficient thickness (or diameter) to preserve an acceptable degree of tensile or tear strength. Depending on the application, the fibers can have an average fiber diameter in the range from 1 micrometer to 100 micrometers, from 2 micrometers to 50 micrometers, from 5 micrometers to 20 micrometers, or in some embodiments, less than, equal to, or greater than 1 micrometer, 2, 3, 5, 7, 10, 15, 20, 25, 30, 40, 50, 60, 70, 80, 90, or 100 micrometers.

Using relatively long fibers can reduce fiber shedding and further enhance strength of the core layer along transverse directions. The non-meltable polymeric fibers can have an average fiber length in the range from 10 millimeters to 100 millimeters, from 15 millimeters to 100 millimeters, from 25 millimeters to 75 millimeters, or in some embodiments, less than, equal to, or greater than 10 millimeters, 12, 15, 17, 20, 25, 30, 35, 40, 45, 50, 55, 60, 65, 70, or 75 millimeters.

The non-meltable fibers used to form the core layer can be prepared from bulk fibers, typically provided in the form of compressed bales. The bulk fibers can be placed on the inlet conveyor belt of an opening/mixing machine in which they can be teased apart and mixed by rotating combs. The fibers are then blown into web-forming equipment where they are formed into a dry-laid core layer.

Alternatively, an air-laying forming apparatus using spike rollers (such as those commercially available from FormFiber NV, Denmark) can be used to prepare nonwoven fibrous webs containing these bulk fibers. Details of the apparatus and methods of using the apparatus in forming air-laid webs are described in U.S. Pat. No. 7,491,354 (Andersen) and U.S. Pat. No. 6,808,664 (Falk et al.). As a further alternative, the non-woven material of the core layer can be formed in an air-laid machine. The web-forming equipment may, for example, be a RANDO-WEBBER device commercially-available from Rando Machine Co., Macedon, N.Y. Yet another possibility is to produce a dry-laid web by carding and cross-lapping, rather than by air-laying. Carding is a process in which bulk fibers are combed by rotating sawtooth wire-covered rolls and bonded to form a fabric. Cross-lapping is used to improve cross-web strength, and can be horizontal (for example, using a PROFILE SERIES cross-lapper commercially-available from ASSELIN-THIBEAU of Elbeuf sur Seine, 76504 France) or vertical (for example, using a WAVE-MAKER system from Santex AG, Tobel, Switzerland).

The non-meltable fibers can be present in an amount sufficient to provide the thermal insulator with the desired flame resistance and thermal insulation properties. The non-meltable fibers can be present in an amount in the range from 60 wt % to 100 wt %, 70 wt % to 100 wt %, 81 wt % to 100 wt %, or in some embodiments, less than, equal to, or greater than 50 wt %, 55, 60, 65, 70, 75, 80, 85, 90, or 95 wt %, or less than or equal to 100 wt %.

In some embodiments, the core layer includes substantial fiber entanglements, which occur when two or more discrete fibers become knotted or twisted together. The fibers within these entanglements, while not physically attached to each other, can be sufficiently intertwined for them to resist separation when the entangled fibers are pulled in opposite directions.

While fiber entanglements are generally created in the plane of most non-woven webs as they are made, entanglements along the thickness dimension are less prevalent, particularly across multiple non-woven layers. Advantageously, such entanglements can be induced by a subsequent needle tacking or hydroentangling process. These processes can provide entanglements in which the fibers in the core layer are substantially entangled along directions perpendicular to the major surfaces of the core layer, thereby enhancing loft and increasing strength of the core layer along these directions.

The core layer can be entangled using a needle tacker commercially available under the trade designation DILO from Dilo of Germany, with barbed needles (commercially available, for example, from Foster Needle Company, Inc., of Manitowoc, Wis.) whereby the substantially entangled fibers described above are needle tacked fibers. Needle tacking, also referred to as needle punching, entangles the fibers perpendicular to the major surface of the core layer by repeatedly passing an array of barbed needles through the web and retracting them while pulling along fibers of the web.

Typically, the core layer is needle tacked to provide an average of at least 5 needle tacks/cm². The mat can be needle tacked to provide an average of 5 to 60 needle tacks/cm², 10 to about 20 needle tacks/cm², or in some embodiments, less than, equal to, or greater than 5, 6, 7, 8, 9, 10, 12, 15, 17, 20, 25, 30, 35, 40, 45, 50, 55, or 60 needle tacks/cm². Further details about needle tacking are described in U.S. Patent Publication Nos. 2006/0141918 (Rienke), 2011/0111163 (Bozouklian et al.), and co-pending International Patent Publication No. 2019/090659 (Cal et al.).

The non-woven materials of the core layer can also be hydroentangled using a water entangling unit (commercially available from Honeycomb Systems Inc., Bidderford, Me.; also see U.S. Pat. No. 4,880,168 (Randall, Jr.)). Hydroentangling is a conversion process for fibrous webs made by carding, air-laying or wet-laying that involves directing fine, high-pressure jets of water penetrate the web and rebound off of a backing to induce entanglement of the non-woven fibers. The resulting bonded fabric is commonly referred to as a spunlaced nonwoven.

Optionally, the core layer further includes secondary fibers that are meltable. Such secondary fibers include binder fibers, which have a sufficiently low melting temperature to allow subsequent melt processing of the core layer. Binder fibers are generally polymeric and may have uniform composition or contain two or more components. Some binder fibers are bi-component fibers comprised of a core polymer that extends along a fiber axis and is surrounded by a cylindrical shell polymer. The shell polymer can have a melting temperature less than that of the core polymer. Binder fibers can, alternatively, be monofilament fibers made from a single polymer.

As used herein, however, “melting” refers to a gradual transformation of the fibers or, in the case of a bi-component shell/core fiber, an outer surface of the fiber, at elevated temperatures at which the polyester becomes sufficiently soft and tacky to bond to other fibers with which it comes into contact, including non-meltable fibers and any other binder fibers having its same characteristics and, as described above, which may have a higher or lower melting temperature.

Useful binder fibers have outer surfaces comprised of a polymer having a melting temperature in the range from 100° C. to 300° C., or in some embodiments, less than, equal to, or greater than, 100° C., 105, 110, 115, 120, 125, 130, 135, 140, 145, 150, 160, 170, 180, 190, 200, 210, 220, 230, 240, 250, 260, 270, 280, 290, or 300° C.

An exemplary suitable bicomponent fiber could have a polyester or nylon core with a low melting polyolefin sheath. As a further example, the bicomponent fiber could have a polyester core with a polyester-polyolefin copolymer sheath such as Type 254 CELBOND fiber provided by Invista North America S.A.R.L., Wichita, Kans. This fiber has a sheath component with a melting temperature of approximately 230° F. (110° C.).

Suitable binder fibers can also include a homopolymer or copolymer in a monofilament construction. These include thermoplastic fibers with softening temperature less than 150° C. (such as polyolefin or nylon). Other suitable monocomponent fibers include thermoplastic fibers with softening temperature less than 260° C. (such as certain polyester fibers, such as polyethylene terephthalate fibers)—for example, TREVIRA 276 fibers provided by Trevira GmbH, Hattersheim, Germany.

Binder fibers increase structural integrity in the thermal insulator by creating a three-dimensional array of nodes where constituent fibers are physically attached to each other. These nodes provide a macroscopic fiber network, which increases tear strength, tensile modulus, preserves dimensional stability of the end product, and reduces fiber shedding. Advantageously, incorporation of binder fibers can allow bulk density to be reduced while preserving structural integrity of the core layer, which in turn decreases both weight and thermal conductivity.

Other secondary fibers may be included to enhance loft, compressibility, and/or tear resistance in the core layer. These secondary fibers can have any suitable diameter. Average fiber diameter can be in the range from 10 micrometers to 1000 micrometers, 15 micrometers to 300 micrometers, 20 micrometers to 100 micrometers, or in some embodiments, less than, equal to, or greater than 10 micrometers, 15, 20, 25, 30, 35, 40, 45, 50, 60, 70, 80, 90, 100, 120, 150, 170, 200, 250, 300, 400, 500, 750, or 1000 micrometers.

Secondary fibers can be present in an amount in the range from 1 wt % to 40 wt %, 3 wt % to 30 wt %, 3 wt % to 19 wt %, or in some embodiments, equal to or greater than 0 wt %, or less than, equal to, or greater than 1 wt %, 2, 3, 4, 5, 7, 10, 15, 20, 25, 30, 35, 40, 45, or 50 wt %, in each case relative to the overall weight of the core layer. In some embodiments, the core layer is devoid of secondary fibers.

Preferred weight ratios of the oxidized polyacrylonitrile fibers to secondary fibers bestow both high tensile strength to tear resistance to the thermal insulator as well as acceptable flame retardancy—for instance, the ability to pass the UL-94V0 flame test. The weight ratio of oxidized polyacrylonitrile fibers to secondary fibers can be at least 4:1, at least 5:1, at least 10:1, or in some embodiments, less than, equal to, or greater than 4:1, 5:1, 6:1, 7:1, 8:1, 9:1, or 10:1.

By reducing the overall effects of thermal conduction and convection, the provided insulating articles can achieve surprisingly low thermal conductivity coefficients. The core layers of the provided thermal insulators can display a thermal conductivity coefficient at ambient conditions of less than 0.035 W/K-m, less than 0.033 W/K-m, less than 0.032 W/K-m, or in some embodiments, less than, equal to, or greater than 0.031 W/K-m, 0.032, 0.033, 0.034, or 0.035 W/K-m, according to ASTM D1518-85 (re-approved 2003). Thermal conductivity coefficients in these ranges can be obtained with the core layer in its relaxed configuration (i.e., uncompressed) or compressed to 20% of its original thickness based on ASTM D5736-95 (re-approved 2001).

To maximize the flame retardancy of the core layer, it can be advantageous to use non-woven materials in which oxidized polyacrylonitrile fibers represent over 85 vol %, over 90 vol %, or over 95 vol %, or in some embodiments, less than, equal to, or greater than 85 vol %, 86, 87, 88, 89, 90, 91, 92, 93, 94, 95, 96, 97, 98, 99, or 100 vol % of the plurality of fibers present in the core layer.

In a preferred embodiment, the oxidized polyacrylonitrile fibers and/or secondary fibers are crimped to provide a crimped configuration (e.g., a zigzag, sinusoidal, or helical shape). Alternatively, some or all of the oxidized polyacrylonitrile fibers and secondary fibers have a linear configuration. The fraction of oxidized polyacrylonitrile fibers and/or secondary fibers that are crimped can be less than, equal to, or greater than 5%, 10, 15, 20, 25, 30, 40, 50, 60, 70, 80, 90, or 100%. Crimping, as described in European Patent No. 0 714 248 (Allen, et al.), can significantly increase the bulk, or volume per unit weight, of the core layer.

Both induced fiber entanglements and fiber crimping can significantly increase the degree of loft in the core layer. In exemplary embodiments, the core layer has an average bulk density in the range from 15 kg/m³ to 50 kg/m³, 15 kg/m³ to 40 kg/m³, 20 kg/m³ to 30 kg/m³, or in some embodiments less than, equal to, or greater than 15 kg/m³, 16, 17, 18, 19, 20, 22, 24, 25, 26, 28, 30, 32, 35, 37, 40, 42, 45, 47, or 50 kg/m³.

In some embodiments, the core layer has a basis weight in the range from 10 gsm to 2000 gsm, from 15 gsm to 100 gsm, from 20 gsm to 45 gsm, or in some embodiments, less than, equal to, or greater than 10 gsm, 15, 20, 25, 30, 35, 40, 45, 50, 60, 70, 80, 90, 100, 200, 300, 400, 500, 600, 700, 800, 900, 1000, 1500, or 2000 gsm.

The dimensions of the core layer are not particularly restricted and generally depend on the application. In exemplary applications, the core layer can have an overall thickness of from 1 millimeter to 100 millimeters, from 2 millimeters to 50 millimeters, from 3 millimeters to 20 millimeters, or in some embodiments, less than, equal to, or greater than 1 millimeter, 2, 3, 4, 5, 6, 7, 8, 9, 10, 12, 15, 17, 20, 25, 30, 35, 40, 45, 50, 60, 70, 80, 90, or 100 millimeters.

Core layers based on lofted non-woven fibrous webs can, in some cases, be highly compressible. Compressibility can also be useful, as to allow a web of the invention to be pressed into and fully occupy a space that is being insulated. These materials can also exhibit good recovery when compressed. The provided core layers can be capable of recovering over 60%, over 70%, over 80%, or in some embodiments, less than, equal to, or greater than 50%, 60, 65, 70, 75, 80, 85, or 90% of its original thickness when compressed, based on the Web Recovery test described in U.S. Pat. No. 7,476,632 (Olson, et al.).

### Reinforcement Layers

In various embodiments, the provided thermal insulators contain at least one discrete reinforcement layer that is laminated, coated, or otherwise attached to one or both major surfaces of the core layer. This layer can serve multiple purposes, such as serving to enhance the strength and/or toughness of the insulator, improving fire resistance, and sealing in any loose fibers in the core layer. The reinforcement layer is typically thinner, has a higher density, and has a higher tensile strength than the core layer.

Various kinds of reinforcement layers are contemplated, including those derived from solid or porous films, and fibrous structures. Layers derived from fibrous structures can be made from either a woven or non-woven web, and optionally include one or more binders.

Woven reinforcement layers can be made using methods known for making woven and knitted fabrics, and non-woven reinforcement layers can be produced using any known technique, including melt blowing, spun lace and spun bond techniques.

Non-woven reinforcement layers have entangled, chemically-bonded or thermally-bonded fibrous structures, and can be made from any of a broad variety of fibers including polyethylene fibers, polypropylene fibers, mixtures of polyethylene and polypropylene fibers, nylon fibers, polyester fibers (such as polyethylene terephthalate), acrylic and modacrylic fibers such as polyacrylonitrile fibers and acrylonitrile and vinylchloride copolymer fibers, polystyrene fibers, polyvinylacetate fibers, polyvinylchloride fibers, rayon, cellulose acetate fibers, glass fibers, viscose fibers, polyamide fibers, polyphenylene sulfide fibers, and any of the carbonaceous fibers based on oxidized polyacrylonitrile described in the prior subsection entitled “Core layers.”

Combinations of the aforementioned fibers may also be used. For example, in some embodiments, fibers of polyphenylene sulfide can be laminated, enmeshed, or entangled with oxidized polyacrylonitrile fibers to provide a reinforcement layer that is tough, permeable and heat resistant. In this blended configuration, the reinforcement layer can be comprised of from 1 wt % to 99 wt %, from 30 wt % to 70 wt %, or from 45 wt % to 55 wt %, of oxidized polyacrylonitrile fibers, and from 1 wt % to 99 wt %, from 30 wt % to 70 wt %, or from 45 wt % to 55 wt % of polyphenylene sulfide fibers, in each case relative to the overall weight of the reinforcement layer. Some of these combinations are described elsewhere, for example, in U.S. Patent Publication No. 2018/0187351 (Tsuchikura et al.).

In other embodiments, fibers of polyethylene terephthalate can be laminated, enmeshed, or entangled with oxidized polyacrylonitrile fibers to provide a reinforcement layer. In this blended configuration, the reinforcement layer can be comprised of from 1 wt % to 99 wt %, 30 wt % to 70 wt %, or from 30 wt % to 70 wt % of oxidized polyacrylonitrile fibers, and from 1 wt % to 99 wt %, 30 wt % to 70 wt %, or from 30 wt % to 70 wt % of polyethylene terephthalate fibers, in each case relative to the overall weight of the reinforcement layer.

In various embodiments, each of the reinforcement layers is composed of flame-resistant fibers. While fiberglass fibers have better intrinsic fire resistance than the aforementioned polymers, even combustible polymers can be provided with significant fire resistance by blending with sufficient amounts of a flame-retardant additive. For example, these reinforcement layers can be made from flame-resistant polyester fibers.

The flame-retardant additive can be either miscible or immiscible with the host polymer. Miscible additives include polymer melt additives such as phosphorus-based flame retardants that contain phenolic end groups. These additives include phosphinates and polyphosphonates, including polyphosphonate homopolymers and copolymers, which can be miscibly blended with polyesters to form flame-resistant fibers. Useful additives are commercially available under the trade designation NOFIA from FRX Polymers, Inc., Chelmsford, Mass. Inclusion of both miscible and immiscible salts can be effective in enhancing fire resistance.

Miscible flame-retardant additives such as those derived from phosphinates, polymeric phosphonates and their derivatives can be preferred in making reinforcement layers with fine fiber diameters, as described in co-pending U.S. Provisional Patent Application No. 62/746,386 (Ren et al.). Polymeric flame-retardants can be advantageous over non-polymeric alternatives because of their lower volatility, decreasing leaching tendency, and improved compatibility with base polymers.

Suitable flame-resistant fibers can be, in some embodiments, capable of passing the UL94-V0 flammability standard when formed into a non-woven web made from 100% of such fibers, and having a base weight of less than 250 gsm and web thickness of less than 6 millimeters.

Suitable reinforcement layers need not be fibrous. A reinforcement layer can be, for example, a continuous film or coating that has been perforated to permit air transmission therethrough. Films and coatings based on materials that are inherently flame-resistant can be preferred. For example, a non-woven fibrous core layer could be reinforced with a film or coating made from a polyimide, polyvinyl (such as polyvinyl chloride), polyetheretherketone (PEEK) or a thermoplastic fluoropolymer, such as a copolymer of tetrafluoroethylene, hexafluoropropylene, and vinylidene fluoride provided under the trade designation “THV” by 3M Company, St. Paul, Minn.

Other useful reinforcement layers can be made from the perforated films described in U.S. Pat. No. 6,617,002 (Wood), U.S. Pat. No. 6,977,109 (Wood), and U.S. Pat. No. 7,731,878 (Wood). The perforated films suitable for use a reinforcement layer include films made from polyvinyl chloride or other polymer that displays some degree of fire resistance.

Perforated films can have an overall thickness of from 1 micrometer to 2 millimeters, from 30 micrometers to 1.5 millimeters, from 50 micrometers to 1 millimeter, or in some embodiments, less than, equal to, or greater than, 1 micrometer, 2, 5, 10, 20, 30, 40, 50, 100, 200, 500, 700 micrometers, 1 millimeter, 1.1, 1.2, 1.5, 1.7, or 2 millimeters.

The perforations can have a wide range of shapes and sizes and may be produced by any of a variety of molding, cutting or punching operations. The cross-section of the perforations can be, for example, circular, square, or hexagonal. In some embodiments, the perforations are comprised of an array of elongated slits.

While the perforations may have diameters that are uniform along their length, it is possible to use perforations that have the shape of a conical frustum, truncated pyramid, or otherwise have side walls tapered along at least some of their length, as described in co-pending International Patent Application No. PCT/US18/56671 (Lee et al.; see, e.g., FIGS. 15a-c and associated description). The degree of taper in the side walls can be chosen to accommodate heterogeneous filler within the perforations. The tapering of the perforations also narrows one side of the apertures, a feature that can help prevent heterogeneous filler from escaping through the perforated film.

Optionally, the perforations have a generally uniform spacing with respect to each other. If so, the perforations may be arranged in a two-dimensional grid pattern or staggered pattern. The perforations could also be disposed on the wall in a randomized configuration where the perforation locations are irregular, but the perforations are nonetheless evenly distributed across the wall on a macroscopic scale.

In some embodiments, the perforations are of essentially uniform diameter along the wall. Alternatively, the perforations could have some distribution of diameters. In either case, the average narrowest diameter of the perforations can be less than, equal to, or greater than 10 micrometers, 15, 20, 25, 30, 35, 40, 45, 50, 60, 70, 80, 90, 100, 110, 120, 150, 170, 200, 250, 300, 350, 400, 450, 500, 600, 700, 800, 900, 1000, 1500, 2000, 2500, 3000, 4000, or 5000 micrometers. For clarity, the diameter of non-circular holes is defined herein as the diameter of a circle having the equivalent area as the non-circular hole in plan view.

Perforations can have an areal density of from 1 per cm² to 100 per cm², from 2 per cm² to 50 per cm², from 5 per cm² to 20 per cm², or in some embodiments, less than, equal to, or greater than 1 per cm², 2, 3, 4, 5, 7, 10, 12, 15, 17, 20, 25, 30, 35, 40, 45, 50, 60, 70, 80, 90, or 100 cm².

The porosity of the perforated film is a dimensionless quantity representing the fraction of a given volume not occupied by the film. In a simplified representation, the perforations can be assumed to be cylindrical, in which case porosity is well approximated by the percentage of the surface area of the wall displaced by the perforations in plan view. In exemplary embodiments, the wall can have a porosity of 0.1% to 80%, 0.5% to 70%, or 0.5% to 60%. In some embodiments, the wall has a porosity less than, equal to, or greater than 0.1%, 0.2, 0.3, 0.4, 0.5, 0.7, 1, 2, 3, 4, 5, 6, 7, 8, 9, 10, 15, 20, 25, 30, 35, 40, 45, 50, 55, 60, 65, 70, 75, or 80%.

The reinforcement layer can be significantly thinner than the core layer. To minimize the weight of the thermal insulator, the reinforcement layers can be made only as thick as necessary to serve the purpose of encapsulating loose fibers in the passive thermal insulator while satisfying any technical requirements for strength and toughness.

An individual reinforcement layer, or two or more reinforcement layers used in combination, can have an overall thickness of from 0.01 millimeters to 2 millimeters, from 0.1 millimeters to 1 millimeter, from 0.5 millimeters to 1 millimeter, or in some embodiments, less than, equal to, or greater than 0.01 millimeters, 0.02, 0.05, 0.1, 0.2, 0.3, 0.4, 0.5, 0.7, 1, 1.2, 1.5, 1.7, or 2 millimeters.

An individual reinforcement layer, or two or more reinforcement layers used in combination, can have a basis weight in the range from 10 gsm to 100 gsm, from 20 gsm to 80 gsm, from 30 gsm to 70 gsm, or in some embodiments, less than, equal to, or greater than 10 gsm, 12, 15, 17, 20, 25, 30, 35, 40, 45, 50, 55, 60, 65, 70, 75, 80, 85, 90, 95, or 100 gsm.

### Binders

The core layer and/or reinforcement layers optionally includes at least one binder that assists in bonding the reinforcement layer and core layer to each other, or bonds either the reinforcement layer or core layer to other adjacent layers or substrates. Binders may be in particulate or emulsified form, or in some cases provided as a continuous film. In some cases, the binder can enable the edge sealing peripheral edges of the insulating article, or any of its constituent layers, to mitigate the problem of fiber shedding. The binder can be disposed onto one or both major surfaces of the reinforcement layer, core layer, reinforcement layers, and/or any other layers or substrates present, and then the binder can be melted or otherwise activated to bond opposing layer surfaces to each other.

Exemplary binders include polymeric binders. Polymeric binders include fluoropolymers, perfluoropolymers, polytetrafluoroethylene, a thermoplastic fluoropolymer such as hexafluoropropylene-vinylidene fluoride-tetrafluoroethylene polymer, vinyl, rubber (including but not limited to Viton, butyl, and fluoroelastomers), polyvinyl chloride, and polymers of urethane, acrylics, or silicone. The binder can, in some embodiments, comprise a blend of a fluoropolymer and a polyimide, a polyamideimide, or a polyphenylene sulfide.

Because the core layer is porous, the binder may significantly penetrate into the pores of the core layer and/or reinforcement layer to form an intermixed, hybrid layer of increased density relative to the virgin core layer. Alternatively, the pore structure and surface energy of the core layer and/or reinforcement layers may be such that the binder only minimally permeates into these layers as it bonds them to each other.

Some polymeric binders, such as thermoplastic binders, can be readily melted to obtain a flowable composition that coats the surfaces to be bonded, and then cooled to close the bond. These materials can be heat laminated to each other in either a manual or continuous process.

Other polymeric binders are curable polymeric binders that crosslink upon being heated, exposed to actinic radiation, or otherwise chemically activated. Curable polymeric binders include water-based latexes such as latexes of polyurethane or (meth)acrylate polymer. Other curable binders include, but are not limited to, epoxies, epoxy curing agents, phenolics, phenols, cyanate esters, polyimides (e.g., bismaleimide and polyetherimides), polyesters, benzoxazines, polybenzoxazines, polybenzoxazones, polybenzimidazoles, polybenzothiazoles, polyamides, polyamidimides, polysulphones, polyether sulphones, polycarbonates, polyethylene terephthalates, cyanates, cyanate esters, polyether ketones (e.g., polyether ketone, polyether ether ketone, polyether ketone ketone), combinations thereof, and precursors thereof.

It is also possible for the binder to include inorganic compositions, such as a silica, alumina, zirconia, kaolin clay, bentonite clay, silicate, micaceous particles, precursors thereof, and any combinations thereof. Inorganic binders are provided as a powder and widely used in cementitious materials. The powder can be activated with water after application and the water removed to form the interlayer bond. When binding a ceramic polycrystalline fiber nonwoven web, inorganic bonds can be formed between ceramic fibers through the firing of a precursor inorganic binder such as a silicone oil (siloxane, polydimethylsiloxane, etc.). Non-woven mats incorporating these inorganic binders are described in co-pending U.S. Provisional Patent Application, Ser. No. 62/670,011 (De Rovere).

The binder can assume any of many different forms. In some embodiments, a polymeric binder is incorporated directly into a non-woven fibrous layer (such as the core layer) through inclusion of binder fibers as described above.

In other embodiments, the binder is provided in the form of a coating. The coating can be disposed in a liquid form on the core layer, reinforcement layer, reinforcement layers, or any combination thereof, and then subsequently solidified. The coating can be applied using any known method, such as solvent casting or hot melt coating. Solvent casting methods including brush, bar, roll, wiping, curtain, rotogravure, spray, or dip coating techniques. In some embodiments, the binder is coated onto the core layer and permeates through the core layer such that the binder is at least partially disposed within the bulk of the material. The binder layer can then be obtained by removing the solvent from the coated binder solution. Solvent removal is generally induced by heat, commonly by drying in an oven.

Exemplary binder coatings include those made from an acrylic polymer latex or polyurethane based latex. Exemplary polymeric binders include those provided under the trade designations POLYCO 3103 (acrylic/vinyl acetate copolymer), RHOPLEX HA-8, and DSM NEWREZ R-966 (polyurethane based latex) by Dow Chemical Company, Midland, Mich. Other useful binder materials include fluorinated thermoplastics, optionally in the form of an aqueous emulsion, such as those provided under the trade designation THV and provided by 3M Company, St. Paul, Minn.

A latex binder can be solvent cast onto a given layer or substrate from an aqueous emulsion. The latex binder can be present in any suitable amount relative to the solids content of the aqueous emulsion. The latex binder can be present in an amount in the range from 1 wt % to 70 wt %, 3 wt % to 50 wt %, 5 wt % to 20 wt %, or in some embodiments, less than, equal to, or greater than 1 wt %, 2, 3, 4, 5, 7, 10, 12, 15, 17, 20, 25, 30, 35, 40, 45, 50, 55, 60, 65 or 70 wt % based on the overall solids weight of the aqueous emulsion.

Ranges similar to those above can apply to binders other than latex binders. For example, the core layer or reinforcement layer can include a binder present in an amount from 1 wt % to 70 wt %, 3 wt % to 50 wt %, 5 wt % to 20 wt %, or in some embodiments, less than, equal to, or greater than 1 wt %, 2, 3, 4, 5, 7, 10, 12, 15, 17, 20, 25, 30, 35, 40, 45, 50, 55, 60, 65 or 70 wt % based on the overall weight of the core layer or reinforcement layer.

Optionally, the binder can also provide improved adhesion between the reinforcement layers and the core layer. This can be achieved by coating the binder onto the bonding surfaces of the reinforcement layer(s) or core layer before placing the reinforcement layers in contact with the core layer. Optionally, the binder can be spray or dip coated onto these inner surfaces from a solution or emulsion.

If the binder is used to form an edge seal, then the coating should be sufficiently thick to provide generally uniform and void-free seal when the reinforcement layers, and optionally the core layer, are subjected to heat and/or pressure. The minimum coating weight for a given application depends on the porosity and thickness of the reinforcement layers and core layer, among other factors. In exemplary embodiments, the coating has a basis weight in the range from 2 gsm to 100 gsm, from 5 gsm to 50 gsm, from 10 gsm to 20 gsm, or in some embodiments, less than, equal to, or greater than 2 gsm, 3, 4, 5, 7, 10, 12, 15, 17, 20, 25, 30, 35, 40, 45, 50, 55, 60, 65, 70, 75, 80, 85, 90, 95, or 100 gsm.

It can be advantageous for the coating to contain other components in addition to the binder. For example, where the binder is not flame-resistant, the coating can further include flame-retardant additives and intumescents.

Useful flame-retardant additives include phosphate-based additives, such as ammonium polyphosphate. Ammonium polyphosphate is an inorganic salt of polyphosphoric acid and ammonia, and may be either a linear or branched polymer. Its generic chemical formula is [NH₄PO₃]ₙ(OH)₂, where each monomer consists of an orthophosphate radical of a phosphorus atom with three oxygens and one negative charge neutralized by an ammonium cation leaving two bonds free to polymerize. In the branched cases some monomers are missing the ammonium anion and instead link to other monomers. Aqueous emulsions of ammonium polyphosphate are commercially available, for example, under the trade designation EXOLIT from Clariant International Ltd., Muttenz, Switzerland. Organophosphates other than ammonium polyphosphate can also be used. It is recognized that phosphates can absorb moisture and reduce electrical resistivity of the core layer and/or reinforcement layers so it is generally preferred to use as little as needed to satisfy requirements for both flame retardancy and electrical resistivity.

Intumescents swell when exposed to heat, and can impede fire propagation by expanding into gaps. In the provided thermal insulators, an intumescent additive can include one or more of: (1) a phosphorus-containing part, provided for example by ammonium polyphosphate, (2) a hydroxyl-containing part that increases char in the event of a fire, such as sucrose, catechol, pentaerythritol, and gallic acid, and (3) a nitrogen-containing part that can act as blowing agent, such as melamine or ammonium. In some embodiments, components (1)-(3) are used in combination. Intumescents can also include graphite filler, such as expandable graphite. Expandable graphite is a synthesized intercalation compound of graphite that expands when heated.

In some embodiments, flame-retardant additives are dissolved or dispersed with the binder in a common solvent and both components are collectively solvent cast onto the reinforcement layers and/or the core layer. For example, ammonium polyphosphate can conveniently be cast from an aqueous emulsion that also contains a polymer latex.

Flame-retardant additives can be present in an amount in the range from 5 wt % to 95 wt %, from 10 wt % to 90 wt %, from 20 wt % to 60 wt %, or in some embodiments, less than, equal to, or greater than 5 wt % 10, 15, 20, 25, 30, 35, 40, 45, 50, 55, 60, 65, 70, 75, 80, 85, 90, or 95 wt % based on the overall solids weight of the coating.

The coating emulsion or solution can have any suitable concentration to provide an appropriate viscosity to provide a uniform coating on the fibers of the reinforcement layers and/or the core layer. For spray coating, it is typical to use a solids content in the range from 1 wt % to 50 wt %, from 2.5 wt % to 25 wt %, from 5 wt % to 15 wt %, or in some embodiments, less than, equal to, or greater than 1 wt %, 1.5, 2, 2.5, 3, 3.5, 4, 4.5, 5, 6, 7, 8, 9, 10, 12, 15, 17, 20, 25, 30, 35, 40, 45, or 50 wt %.

### EXAMPLES

Objects and advantages of this disclosure are further illustrated by the following non-limiting examples, but the particular materials and amounts thereof recited in these examples, as well as other conditions and details, should not be construed to unduly limit this disclosure. Unless otherwise noted, all parts, percentages, ratios, etc. in the Examples and the rest of the specification are by weight.

TABLE 1
Materials

| Designation | Description | Source |
|---|---|---|
| OPAN | Oxidized polyacrylonitrile staple | ZOLTEK Corporation |
| | fibers, 1.7 dTex available under the | (wholly owned |
| | trade designation “OX” | subsidiary of Toray |
| | | Group), Bridgeton, |
| | | MO, United States |
| T276 | A flame-retardant polyethylene | Trevira GmbH, |
| | terephthalate staple fiber, 3.3 dTex, | Hattersheim, Germany. |
| | available under the trade | |
| | designation “TREVIRA 276” | |
| PET Liner | One side silicone treated | Mitsubishi Polyester |
| | polyethylene terephthalate available | Film, Greer, SC, United |
| | under the trade designation | States. |
| | “215KN” | |
| THV340Z | Dispersion (50 wt %) of a polymer | 3M Company, Saint |
| | of tetrafluoroethylene, | Paul, MN, United States |
| | hexafluoropropylene, and | |
| | vinylidene fluoride available under | |
| | the trade designation “3M | |
| | DYNEON Fluoroplastic THV340Z” | |
| BC765 | A polyethylene terephthalate scrim | Precision Fabrics |
| | material, 70 gsm, available under | Group, Inc., Greensboro, |
| | the trade designation “NEXUS | NC, United States |
| | BC765” | |
| MT | A homogeneous polyimide film | DuPont, Wilmington, |
| | available under the trade | DE, United States |
| | designation ”KATPON MT” | |
| GULFENG | A flame-retardant nonwoven fabric | Toray Industries, Inc., |
| | available under the trade | Tokyo, Japan |
| | designation “GULFENG” | |
| LATEX | Acrylic copolymer flame-retardant | Lubrizol, Wickliffe, |
| | emulsion available under the trade | OH, United States |
| | designation “HYCAR 26-0912” | |
| AP420 | Ammonium phosphate available | Clariant, Muttenz, |
| | under the trade designation | Switzerland |
| | “EXOLIT AP420” | |
| CA-421 | A vinyl architectural film with | 3M Company, Saint |
| | acrylic pressure sensitive adhesive | Paul, MN, United States |
| | and silicone release liner available | |
| | under the trade designation “DI- | |
| | NOC CA-421” | |

### Test Methods

Nonwoven Web Thickness Measurement: The method of ASTM D5736-95 was followed, according to test method for thickness of high loft nonwoven fabrics. The plate pressure was calibrated at 13.79 pascals (0.002 psi).
UL94-V0 Flame Test: Reference to UL94-V0 standard with flame height of 20 millimeters (mm), the bottom edge of the sample placed 10 mm into the flame, and two burns at 10 seconds each. A flame propagation height under 125 mm (5 inches) was considered a pass.
Mechanical Test: The methods of ASTM D882-18 and ASTM D1938-19 were followed.
Flexibility Test: The methods of ASTM D2923-06 for polymer films or ASTM D6828-02 for fabric were followed. A Handle-O-Meter 211 (AN-7-315) obtained from Thwing-Albert Instrument Company of West Berlin, N.J., United States was used for testing. A sample was pinned down to fit into a 20-mm wide gap, and the pin down force in grams was recorded. Each sample was tested four times along each of the x and y directions and the average value was recorded.
Surface Electrical Resistivity Test: The methods of ASTM D325-31 were followed with modification. Samples were hung inside a Thermotron Environmental Chamber of Holland, Mich., United States. Resistivity was measured by connecting to the sample two electrodes (spaced 25 mm apart) of a Fluke 1507 Insulation Resistance Tester obtained from Fluke of Everett, Wash., United States. The electrode wires were guided externally to the chamber and the Thermotron was sealed. Temperature and humidity parameters were set at 30° C. and 85% RH and the system idled for twelve hours to condition the sample. Two samples were measured for each example or comparative example and an average value for resistivity in M-ohm was recorded.
Airflow Resistance Test: The methods of ISO9053-91 and ASTM C522-03 were followed. A Sigma Static Airflow Meter from Mecanum of Sherbrooke, Canada was used to record mean airflow resistance (measured in Pas/m or MKS Rayls).
All assembled samples were 300 mm×300 mm (12 inch×12 inch).

### Example 1 (EX1)

An 80 wt % OPAN and 20 wt % T276 blended web was produced as described in the commonly owned PCT Patent Publication No. WO 2015/080913 (Zillig et al). The web was folded upon itself (changing basis weight to 150 gsm) and was then conveyed by a Dilo Needle Loom, Model DI-Loom OD-1 6 from Eberbach, Germany having a needle board array of 23 rows of 75 needles/row where the rows are slightly offset to randomize the pattern. The needles were Foster 20 3-22-1.5B needles. The array was roughly 17.8 cm (7 inches) deep in the machine direction and nominally 61 cm (24 inches) wide with needle spacings of roughly 7.6 mm (0.30 inches). The needle board was operated at 91 strokes/minute to entangle and compact the web to a roughly 5.1-mm (0.20 inch) thickness. The basis weight of the web was 150 gsm±10%.

A 55 gsm GULFENG nonwoven fabric was placed on top of a PET Liner with the silicone release side in contact with the fabric. A 150 gsm THV340Z binder solution (diluted from 50 wt % to 10 wt % solid content by adding 4 parts water to 1 part solution) was coated onto a GULFENG nonwoven fabric using a size 22 Mayer rod. The THV340Z coated GULFENG nonwoven fabric was dried at ambient conditions. Another THV340Z coated GULFENG nonwoven fabric with PET release liner was assembled creating another scrim. The two 100-micrometer thick 70 gsm THV treated GULFENG nonwoven fabric scrims were placed one on the top and another on the bottom of the OPAN and T276 blended web and the sample was heated at 150° C. for five minutes. The sample underwent UL94-V0 Flame, Mechanical, Flexibility, Electrical Resistivity, and Airflow testing. Results are represented in Table 2 and Table 3.

### Example 2 (EX2)

An OPAN and T276 blended web was produced as described in Example 1. The OPAN and T276 blended web were submerged in a THV340z solution (diluted to 5% solids). Excess water was removed. The THV coated OPAN and T276 blended web was then placed on top of a PET Liner and placed into a 150° C. oven for 30 minutes. The dried basis weight was 200 gsm±10%. The sample thickness was measured to be 4 mm after the oven process. The sample underwent UL94-V0 Flame, Mechanical, Flexibility, Electrical Resistivity, and Airflow testing. Results are represented in Table 2 and Table 3.

### Comparative Example 1 (CE1)

An OPAN and T276 blended web was produced as described in Example 1.

A 40 gsm web was produced with 100 wt % OPAN as described in Example 1 without the coating applied. The 100 wt % OPAN web was placed on top of a 25 gsm Unipoly 75 MRF PET sheet obtained from Midwest Filtration LLC of Cincinnati, Ohio, United States and needle-tacked (as described in Example 1) to form a bilayer web (with the OPAN web positioned on top of the PET web). The basis weight of the web was 65 gsm±10%.

The bilayer OPAN-PET web was placed on a PET Liner with the silicone release side in contact with the web. A 150 gsm THV340Z binder solution (diluted from 50 wt % to 10 wt % solid content by adding 4.0 parts of water to the one part of the solution) was coated onto the bilayer OPAN-PET web using a size 22 Mayer rod. The THV340Z coated dual layer OPAN-PET nonwoven web was dried at ambient conditions. Another THV3400Z coated bilayer OPAN-PET nonwoven with PET Liner was assembled creating another scrim. The two 100-micrometer thick 80 gsm THV340z treated dual layer OPAN-PET nonwoven fabric scrims were placed on the top and bottom of the OPAN and T276 blended web, with the PET layers in contact with the core, and the sample was heated at 150° C. for five minutes. The sample underwent UL94-V0 Flame, Mechanical, Flexibility, Electrical Resistivity, and Airflow testing. Results are represented in Table 2 and Table 3.

### Comparative Example 2 (CE2)

An OPAN and T276 blended web was produced as described in Example 1.

The OPAN and T276 blended web was encapsulated with a perforated CA421 film. The film was perforated by laser drilling 270 micrometer diameter holes spaced three millimeters apart. The CA421 release liner was removed and the film was placed one on the top and another on the bottom of the 150 gsm blended web. The basis weight of the sample was 750 gsm±10%. The sample underwent UL94-V0 Flame, Mechanical, Flexibility, Electrical Resistivity, and Airflow testing. Results are represented in Table 2 and Table 3.

### Comparative Example 3 (CE3)

An OPAN and T276 blended web was produced as described in Example 1. BC765 scrims were placed one on the top and another on the bottom of OPAN and T276 blended web. The sample was uniformly compressed at 140° C. by a hand calendar roller to a 6 mm thickness. The basis weight of the sample was 290 gsm±10%. This sample is identical to an article made in accordance to Examples 1 and 2 in co-pending PCT Patent Application No. CN2018/096648 (Li et al). The sample underwent UL94-V0 Flame, Mechanical, Flexibility, Electrical Resistivity, and Airflow testing. Results are represented in Table 2 and Table 3.

### Comparative Example 4 (CE4)

An OPAN and T276 blended web was produced as described in Example 1. 25-micrometer thick KAPTON MT polyimide films were placed one on the top and another on the bottom of the OPAN and T276 blended web. The sample was uniformly compressed at 150° C. by a hand calendar roller to a 6 mm thickness. The basis weight of the sample was 190 gsm±10%. The sample underwent UL94-V0 Flame, Mechanical, Flexibility, Electrical Resistivity, and Airflow testing. Results are represented in Table 2 and Table 3.

### Comparative Example 5 (CE5)

An OPAN and T276 blended web was produced as described in Example 1. 300-micrometer thick 55 gsm GULFENG nonwoven fabrics were placed one on top and another on the bottom of the OPAN and T276 blended web. The sample was uniformly compressed by a hand roller to a 6 mm thickness. The basis weight of the sample was 260 gsm±10%. The sample underwent UL94-V0 Flame, Mechanical, Flexibility, Electrical Resistivity, and Airflow testing. Results are represented in Table 2 and Table 3.

### Comparative Example 6 (CE6)

An OPAN and T276 blended web was produced as described in Example 1.

A GULFENG nonwoven fabric was placed on top of a PET Liner with silicone release side in contact with the fabric. A one-part LATEX and 0.5-part AP420 formulation was coated onto a GULFENG nonwoven fabric using a size 22 Mayer rod. The LATEX and AP420 coated GULFENG nonwoven fabric was dried at ambient conditions. Another LATEX and AP420 coated GULFENG nonwoven fabric with PET Liner was assembled to create another fabric scrim. The two 100-micrometer thick 70 gsm LATEX and AP420 treated GULFENG nonwoven fabric scrims were placed one on the top and another on the bottom of the OPAN and T276 blended web and the sample was heated at 150° C. for 5 minutes. The sample was uniformly compressed by a hand roller to a 6 mm thickness. The basis weight of the sample was 290 gsm±10%. The sample underwent UL94-V0 Flame, Mechanical, Flexibility, Electrical Resistivity, and Airflow testing. Results are represented in Table 2 and Table 3.

### Comparative Example 7 (CE7)

An OPAN and T276 blended web was produced as described in Example 1.

Another web was produced with 100 wt % OPAN as described in Example 1. The basis weight was 15 gsm±10%. The 100 wt % OPAN web was placed on a first PET liner with the silicone release side in contact with the 100 wt % OPAN web. A 100 gsm THV340Z binder solution (diluted from 50 wt % to 15 wt % solid content by adding two parts of water to the one part of the solution) was spray coated onto the 100 wt % OPAN web. The 100 wt % OPAN web with binder at 3 mm thickness was uniformly compressed by a hand roller to a 0.5 mm thickness. The 100 wt % OPAN web with binder, supported by the PET liner, was then placed into an ISOTEMP Oven from Fisher Scientific of Waltham, Mass., United States at 160° C. (320° F.) oven for 2-4 minutes to dry producing a 15 gsm±10% dry coating of the THV340Z binder. The sample was then calendared at a gap of 1.5 mil and speed of 0.3048 m/min (1 ft./min) in the oven with an upper temperature setting of 152° C. (305° F.) and lower temperature of 154° C. (310° F.). The basis weight of the sample was 30 gsm±10%.

The THV treated 100% OPAN scrim was laminated to the OPAN and T276 blended web. The blanket basis weight was 210 gsm. The sample underwent UL94-V0 Flame, Mechanical, Flexibility, Electrical Resistivity, and Airflow testing. Results are represented in Table 2 and Table 3.

### Comparative Example 8 (CE8)

A 150 gsm OPAN and T276 blended web was produced as described in Example 1. The OPAN and T276 blended web was positioned between two 300 gsm (one was placed on top and the other on the bottom) flame-resistant nylon microperforated films assembled per the techniques described in commonly owned U.S. Pat. No. 6,598,701 (Wood et al). The perforated hole diameter on the nylon film was 100 microns with holes spaced 1 mm apart. The basis weight of the web was 750 gsm±10%. The sample underwent UL94-V0 Flame, Mechanical, Flexibility, Electrical Resistivity, and Airflow testing. Results are represented in Table 2 and Table 3.

### Comparative Example 9 (CE9)

A 12.7 mm CDM050-40 panel obtained from Zodiac Aerospace (a subsidiary of Safran) of Plaisir, France was laser perforated with 300 micrometer diameter holes spaced 3 mm apart and underwent UL94-V0 Flame, Flexibility, Electrical Resistivity, and Airflow testing. Results are represented in Table 2 and Table 3.

### Comparative Example 10 (CE10)

An OPAN and T276 blended web was produced as described in Example 1. Two fluoroplastic PVDF based membrane films were assembled as described in Example 1 of U.S. Pat. No. 8,182,908 (Mrozinski). The basis weight of the PVDF porous membrane was 300 gsm. The PVDF membranes were placed on top and bottom of the OPAN and T276 blended web. The basis weight of the web was 750 gsm±10%. The sample underwent UL94-V0 Flame, Mechanical, Flexibility, Electrical Resistivity, and Airflow testing. Results are represented in Table 2 and Table 3.

### Comparative Example 11 (CE11)

A 25-millimeter thick BASOTECT open-cell melamine resin foam sample obtained from BASF of Ludwigshafen, Germany underwent UL94-V0 Flame, Mechanical, Flexibility, Electrical Resistivity, and Airflow testing. Results are represented in Table 2 and Table 3.

### Comparative Example 12 (CE12)

One 0.1-millimeter thick mica board was placed on the top and another 0.1 mm thick mica board was placed on the bottom of a 10-millimeter thick NOMEX 994 pressboard, each obtained from DuPont of Wilmington, Del., United States. The sample underwent UL94-V0 Flame, Mechanical, Flexibility, Electrical Resistivity, and Airflow testing, and results are represented in Table 2 and Table 3.

TABLE 2
Flame, Mechanical, Resistivity, and Airflow Test Results

| | | Mechanical | | | |
|---|---|---|---|---|---|
| | | Tensile | | | Airflow |
| | | N/mm | Tear | Resistivity | (MKS |
| Example | Flame | (lbf/in) | N (lbf) | (M-ohm) | Rayls) |
| EX1 | Pass | 1.3 | 11.7 | 128.8 | 200 |
| | | (7.42) | (2.63) | | |
| EX2 | Pass | 2.2 | 22.0 | 94.9 | 200 |
| | | (12.56) | (4.95) | | |
| CE1 | Pass | 0.2 | 1.1 | 132.7 | 200 |
| | | (1.14) | (0.25) | | |
| CE2 | Pass | 1.9 | 0.4 | 65.5 | 2000 |
| | | (10.84) | (0.09) | | |
| CE3 | Pass | 1.8 | 9.7 | 3.6 | 650 |
| | | (10.27) | (2.18) | | |
| CE4 | Pass | 1.4 | 0.16 | 140.4 | >10,000 |
| | | (7.99) | (0.04) | | |
| CE5 | Pass | 0.7 | 5.1 | 149.3 | 10 |
| | | (4.0) | (1.15) | | |
| CE6 | Pass | 1.9 | 8.3 | 3.9 | 200 |
| | | (10.84) | (1.87) | | |
| CE7 | Pass | 0.3 | 0.5 | 163.3 | 50 |
| | | (1.71) | (0.11) | | |
| CE8 | Pass | 12.2 | 0.6 | 123.0 | 1200 |
| | | (69.63) | (0.13) | | |
| CE9 | Pass | 22.9 | 4.8 | 76.3 | 1200 |
| | | (130.71) | (1.08) | | |
| CE10 | Pass | 0.4 | 0.4 | 199.7 | >2000 |
| | | (2.28) | (0.09) | | |
| CE11 | Pass | 0.4 | 0.7 | 55.5 | 100 |
| | | (2.28) | (0.16) | | |
| CE12 | Pass | 1.5 | 15.0 | 122.8 | >2000 |
| | | (11.42) | (3.37) | | |

TABLE 3
Flexibility Test Results (grams)

| Example | Flexibility |
|---|---|
| EX1 | 23.6 |
| EX2 | 102.3 |
| CE1 | 6.7 |
| CE2 | 64.8 |
| CE3 | 3.3 |
| CE4 | 3.2 |
| CE5 | 1.2 |
| CE6 | 23.5 |
| CE7 | 6.8 |
| CE8 | 102.3 |
| CE9 | 102.3 |
| CE10 | 22.1 |
| CE11 | 102.3 |
| CE12 | 89.4 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

What is claimed is:

1. An insulating article comprising:
a core layer containing a plurality of non-meltable fibers; and
optionally, a reinforcement layer disposed on the core layer,
wherein the insulating article has tensile strength of at least 0.75 newtons/millimeter according to ASTM D822 and a tear strength of at least 2 newtons under ASTM D1938,
wherein the insulating article has a surface electrical resistivity of at least 15 M-ohm at a relative humidity of 85% and temperature of 30° C.,
wherein the insulating article has an air flow resistance of up to 2000 MKS Rayls according to ASTM C522, and
wherein the insulating article displays a UL94-V0 flammability rating.

2. The insulating article of claim 1, wherein the insulating article has an average flexibility of up to 50 grams, as measured according to the Flexibility Test.

3. The insulating article of claim 1, wherein non-meltable fibers comprise oxidized polyacrylonitrile fibers.

4. The insulating article of claim 1, wherein the reinforcement layer comprises a thermoplastic fluoropolymer.

5. The insulating article of claim 4, wherein the thermoplastic fluoropolymer comprises a copolymer of tetrafluoroethylene, hexafluoropropylene, and vinylidene fluoride.

6. The insulating article of claim 1, wherein the reinforcement layer comprises a plurality of oxidized polyacrylonitrile fibers.

7. The insulating article of claim 6, wherein the reinforcement layer further comprises fibers comprised of polyphenylene sulfide enmeshed with the oxidized polyacrylonitrile fibers.

8. The insulating article of claim 6, wherein the reinforcement layer further comprises fibers comprised of polyethylene terephthalate enmeshed with the oxidized polyacrylonitrile fibers.

9. The insulating article of claim 6, wherein the reinforcement layer further comprises a thermoplastic fluoropolymer disposed on at least some of the enmeshed fibers.

10. The insulating article of claim 9, wherein the thermoplastic fluoropolymer comprises a copolymer of tetrafluoroethylene, hexafluoropropylene, and vinylidene fluoride.

11. The insulating article of claim 1, wherein the reinforcement layer comprises a perforated film.

12. The insulating article of claim 11, wherein the perforated film comprises polyvinyl chloride or polyimide.

13. A battery assembly comprising a battery at least partially enclosed by the insulating article of claim 1.

14. The battery assembly of claim 13, wherein the battery is an electric vehicle battery.

15. A method of insulating an electric vehicle battery, the method comprising at least partially enclosing the electric vehicle battery with the insulating article of claim 1.
